(19) United States
(12) Patent Application Publication
(10) Pub. No.: US 2002/0187382 A1
(43) Pub. Date: Dec. 12, 2002

(54) Mounting structure of fuel cell assembly on vehicle body

(76) Inventors: Hiroaki Nishiumi, Toyota-shi (JP); Yutaka Hotta, Toyota-shi (JP)

Correspondence Address: KENYON & KENYON, 1500 K STREET, N.W., SUITE 700, WASHINGTON, DC, 20005, US

(21) Appl. No.: 10/160,180

(22) Filed: Jun. 4, 2002

(30) Foreign Application Priority Data
Jun. 11, 2001 (JP) 2001-175674
Jun. 6, 2001 (JP) 2001-170518

(51) Int. Cl. H01M 8/04; B60L 11/18; H01M 8/24

(52) U.S. Cl. 429/34; 429/37; 429/23; 180/65.3

(57) ABSTRACT

A mounting structure of a vehicle body and a fuel cell assembly installed on the vehicle body, wherein a fuel-cell stack is disposed in a front portion of the vehicle body such that the direction of lamination of fuel-cells of the stack is parallel to the lateral direction of the vehicle and such that the power output portion of the stack faces generally in the lateral direction. Terminals of electrodes of the stack partially extend outwardly of the stack, through openings formed through an end plate of the stack, and the terminals are connected through a flexible bus bar to a relay attached to the end plate.

### INCORPORATION BY REFERENCE

The disclosure of Japanese Patent Application No. 2001-175674 filed on Jun. 11, 2001 and No. 2001-170518 filed Jun. 6, 2001, including the specification, drawings and abstract, is incorporated herein by reference in its entirety.

### BACKGROUND OF THE INVENTION

1. Field of the Invention

The present invention relates in general to an arrangement for installing a fuel cell on a vehicle body, and more particularly to techniques for protecting the fuel cell upon crashing of the vehicle.

2. Description of the Related Art

An automotive vehicle using a fuel cell as a drive power or energy source has recently been attracting an attention and developed, in an effort to solve environmental problems. For instance, there has been developed a fuel-cell powered vehicle wherein a fuel cell is installed in a generally central portion of the vehicle body, for instance, in a space provided under the seats, in view of weight balancing of the vehicle and positioning of various components on the vehicle body. It has recently proposed to locate the fuel cell in a front portion of the vehicle body. Such developments of the fuel-cell powered vehicle are actively in progress for practical marketing and wide use in the near future.

A fuel cell of solid polyelectrolyte type consists of at least one stack of cells, each stack consisting of a laminar structure of cell modules, and two sets of a terminal electrode, an insulator and an end plate which are disposed at the respective opposite ends of the laminar structure of cell modules that are opposed to each other in the direction of lamination. Each module consists of a membrane-electrode assembly (MEA) and a separator. The membrane-electrode assembly consists of: an electrolyte membrane that is an ion-exchange membrane; an electrode (anode, i.e., fuel electrode or negative electrode) which is disposed on one of the opposite surfaces of the electrolyte membrane and which consists of a catalyst layer and a diffusion layer; and another electrode (cathode, i.e., air electrode or positive electrode) which is disposed on the other surface of the electrolyte membrane and which also consists of a catalyst layer and a diffusion layer. The separator has fluid passages for supplying the anode and cathode with a fuel-gas (anode gas or hydrogen) and an oxidizing gas (cathode gas, or oxygen, usually, air). The stack includes tightening members (e.g., tension plates) disposed in contact with the laminar structure of cell modules so as to extend in the direction of lamination of the laminar structure, for thereby tightening and fixing the cells of the stack together.

In the solid polyelectrolyte type fuel cell, a reaction takes place on the anode side, to decompose hydrogen into hydrogen ions and electrons, and the hydrogen ions permeate through the electrolyte membrane toward the cathode side, while a reaction takes place on the cathode side, such that water is produced from oxygen, hydrogen ions and electrons (which are produced by the anode of the MEA of the adjacent cell and are moved through the separator to the cathode side of the cell in question). These reactions are expressed as follows:

Reaction on the anode side: H₂→2H⁺+2e⁻

Reaction on the cathode side: 2H⁺+2e⁻+(½)O₂→H₂O

To induce the above reactions, the fuel gas and the oxidizing gas are circulated through the stack of cells. Since a Joule heat is generated by the separator while a heat is generated by production of water on the cathode side, the fuel cell is cooled by a refrigerant (which is usually a cooling water) flowing through a refrigerant passage formed between the adjacent separators, for each cell or a plurality of cells.

Japanese Patent Laid-Open Publication No. 2001-76751 discloses a piping arrangement for supplying a plurality of fuel-cell stacks with the fuel gas, oxidizing gas and refrigerant.

Where the fuel cell is installed in the front portion of the vehicle body, as described above, a care should be taken to protect the fuel cell in the event of a crashing of the vehicle. In particular, it is necessary to protect a power output portion of the fuel cell which has a high voltage and which includes or is surrounded by a power-disconnect relay provided to protect electric circuits and distributors provided to introduce hydrogen and oxygen into the fuel cell. The piping arrangement for the fuel gas, oxidizing gas and refrigerant disclosed in the above-indicated publication Japanese Patent Laid-Open Publication No. 2001-76751 is not designed for safety of fuel-cell stack installed in the vehicle body. Namely, an outlet-side hydrogen pipe is branched so as extend on both sides of the stack, and has an accordingly large length, so that the hydrogen pipe is likely to be damaged. It is also noted that the hydrogen pipe is not protected by the other pipes such as the air pipe and coolant pipe.

### SUMMARY OF THE INVENTION

It is an object of the present invention to provide a combination of a vehicle body and a fuel cell installed on the vehicle body arranged to improve safety of the vehicle upon crashing of the vehicle, in particular, to reduce damaging of fuel-gas pipes connected to the fuel cell.

The above object may be achieved according to the principle of this invention, which provides a combination of a vehicle body and a fuel cell installed on the vehicle body, wherein the fuel cell includes a power output portion and is installed in a front portion of the vehicle body such that said power output portion faces generally in a lateral direction of the vehicle.

### BRIEF DESCRIPTION OF THE DRAWINGS

The above and other objects, features, advantages, and technical and industrial significance of this invention will be better understood by reading the following detailed description of preferred embodiments of the invention, when considered in connection with the accompanying drawings, in which:

FIG. 1 is a schematic plan view showing a combination of a body of a fuel-cell powered vehicle and a fuel cell module installed on a front portion of the vehicle body, which combination is arranged according to one embodiment of this invention;

FIG. 2 is a schematic perspective view showing an arrangement of a power output portion of the fuel cell module, which includes terminal electrodes whose terminals extend through openings formed an end plate of the module;

FIG. 3 is a schematic perspective view showing an arrangement of a flexible bus bar used in the fuel cell module;

FIG. 4 is a schematic view showing an overall arrangement of a fuel cell including a piping system according to a second embodiment of this invention;

FIG. 5 is a fragmentary enlarged view in cross section of the fuel cell of FIG. 4;

FIG. 6 is a plan view of a two-stack type fuel cell according to the second embodiment;

FIG. 7 is a front elevational view of an end plate of the fuel cell including the piping system according to the second embodiment, which end plate is located at the end of the fuel cell on the pipe connecting side;

FIG. 8 is a front elevational view of various pipes attached to the end plate of FIG. 7;

FIG. 9 is a plan view of an engine compartment of a fuel-cell powered automotive vehicle equipped with the fuel cell including the piping system according to the piping system of the second embodiment;

FIG. 10 is a perspective view showing connections of various manifolds and various fluid passages within the fuel cell stack.

### DETAILED DESCRIPTION OF THE PREFERRED EMBODIMENT

The preferred embodiments of the present invention will be described by reference to the drawings.

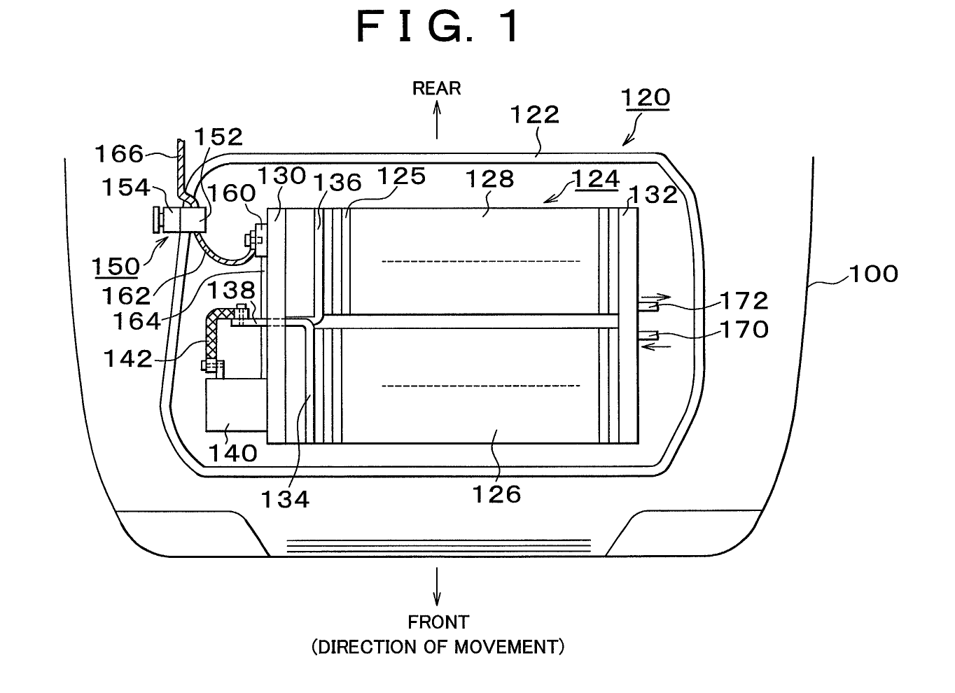

Referring to the plan view of FIG. 1, there is schematically shown a combination of a body of a fuel-cell powered vehicle and a fuel cell module 120 installed on a front portion of the vehicle body 100, which combination is arranged according to one embodiment of this invention. As shown in FIG. 1, the fuel cell module 120 is installed within an engine room or compartment located at the front portion of the vehicle body 100. The fuel cell module 120 includes a fuel-cell stack casing 122 (hereinafter referred to simply as “casing 122”), and a fuel-cell stack 124 accommodated in the casing 122. Although the fuel-cell stack 124 is fluid-tightly accommodated in the casing 122, an upper wall of the casing 122 as shown in FIG. 1 is removed to show the arrangement of the fuel-cell stack 124 and the related components which are received within the casing 122.

The fuel-cell stack 124 consists of a first stack 126 and a second stack 128 which are arranged in parallel with each other. Each of the first and second stacks 126, 128 is a stack of cells 125 in the form of plates laminated on each other. The cells 125 of each of the first and second stacks 126, 128 are laminated or superposed on each other in a lateral or transverse direction of the vehicle (in the right and left direction as seen in FIG. 1). The cells 125 of the first and second stacks 126, 128 are forced against each other in the direction of lamination by two metallic end plates 130, 132 which are disposed at the respective longitudinal ends of the stacks 126, 128 and which have a comparatively large thickness (for instance, about 15 mm). The cells 125 of the first stack 126 and the cells 125 of the second stack 128 are laminated such that the polarity of each cell 125 of the first stack 126 is opposite to that of each cell 125 of the second stack 128. For instance, the left and right sides of each cell 125 of the first stack 126 as seen in FIG. 1 are positive and negative sides, respectively, while the left and right sides of each cell 125 of the second stack 128 are negative and positive sides, respectively. The first and second stacks 126, 128 are electrically connected to each other at their corresponding ends on the side of the end plate 132, whereby the first and second stacks 126, 128 cooperate to constitute a single array of fuel cells 125 in series connection with each other, which provides a desired high voltage.

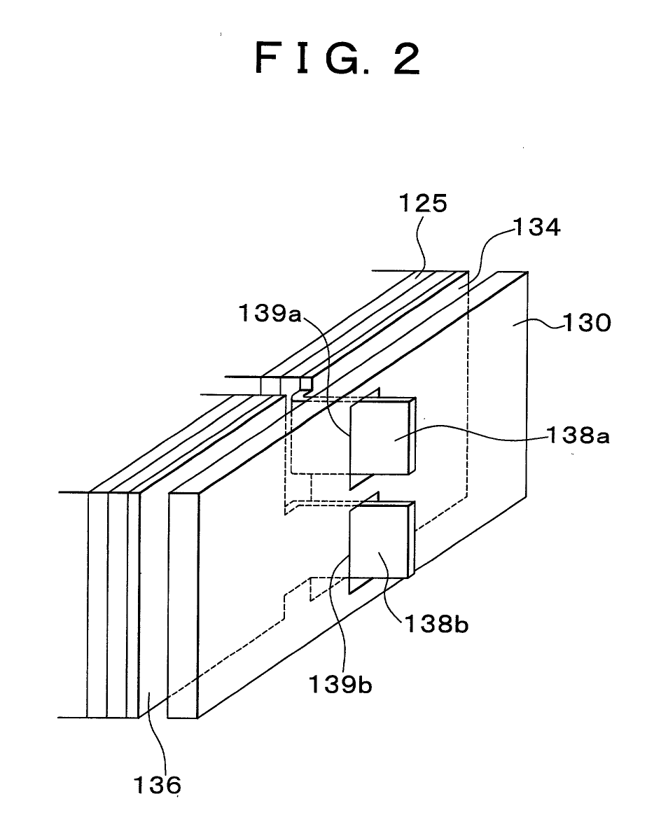

On the end faces of the first and second stacks 126, 128 on the side of the end plate 130, there are superposed respective terminal electrodes 134, 136 for the single array of fuel cells 125 constituted by the two stacks 126, 128. According to the arrangement of the cells 125 as described above, the terminal electrode 134 superposed on the end face of the first stack 126 functions as the positive electrode or cathode, while the terminal electrode 136 superposed on the end face of the second stack 128 functions as the negative electrode or anode. Each of the terminal electrodes 134, 136 is L-shaped and has an end portion which extends in the direction of lamination of the stacks 126, 128 and which functions as a terminal 138, as shown in FIG. 2. The terminals 138 of the two terminal electrodes 134, 138 extends through respective elongate openings 139 formed through a central portion of the end plate 130 as seen in the longitudinal direction of the vehicle, as described below in detail by reference to FIG. 2. Thus, the terminals 138 which extend in the lateral direction of the vehicle are located at a boundary between the first and second stacks 126, 128, that is, at a central portion of the fuel-cell stack 124.

Referring to the schematic perspective view of FIG. 2, there is illustrated a power output portion of the fuel-cell module 120, which includes the terminal electrodes 134, 136 having the terminals 138 that extend through the elongate openings 139 formed through the end plate 130. The elongate openings 139 formed through the central portion of the end plate 130 consist of an upper opening 139a through which the terminal 138a of the electrode 134 extends outwardly of the end plate 130, and a lower opening 139b through which the terminal 138b of the electrode 136 extends outwardly of the end plate 130.

The two end plates 130, 132 are fixed to the casing 122. In view of a variation in the dimension of the two stacks 126, 128 in the direction of lamination of the cells 125 due to thermal expansion and contraction, two stacks of coned disc springs (not shown) are interposed between the end plate 130 and the respective terminal electrodes 134, 136, so that the cells 125 of each of the two stacks 126, 128 are held in pressing contact with each other with an optimum force.

To the outer surface of the end plate 130, there are attached a relay 140 and other components such as an electric circuit devices and distributors (not shown). The relay 140 is electrically connected through a flexible bus bar 142 to the positive and negative terminals 138 extending through the openings 139 of the end plate 130. The flexible bus bar 142 is fixed by screws to the terminal of the relay 140 and to the terminals 138. The relay 140 is provided to inhibit and permit a supply of the electric power from the fuel cell module 120, according to an external control signal. For example, the relay 140 is normally placed in an ON state, for instance, during running of the vehicle, to permit the supply of the electric power from the fuel cell module 120, and is turned to an OFF state in response to a control signal generated in the event of detection of crashing of the vehicle by a crash sensor (not shown), for example, to inhibit the supply of the electric power from the fuel cell module 120.

Upon normal crashing of an automotive vehicle during running, the vehicle tends to receive a comparatively large impact force in the longitudinal or running direction. In view of this tendency, the relay 140 and the other components are attached to the surface of the end plate 130 which faces in the lateral direction of the vehicle. This arrangement is effective to reduce the impact force in the longitudinal direction, and prevent or reduce damages of the relay 140 and the other components. In this respect, it is noted that the end plate 130, which cooperates with the other end plate 132 to force the cells 125 of the fuel-cell stack 124 against each other, is a sturdy member having a sufficiently high value of rigidity. Accordingly, the end plate 130 is highly resistant to a compressive force in a direction parallel to its surface which forces the fuel-cell stack 124. Therefore, the end plate 130 disposed so as to extend in the longitudinal or running direction of the vehicle is less likely to be subject to deformation or destruction due to the compressive force applied thereto in the longitudinal direction of the vehicle, so that the relay 140 attached to the end plate 130 is suitably protected from the impact force. The protection of the relay 140 is particularly important to improve safety upon crashing of the vehicle, since the relay 140 functions to inhibit the supply of the electric power from the fuel cell module 120, for thereby preventing electrical leakage or short-circuiting.

The relay 140 and the other components attached to the end place 130 may be electrically connected to the fuel-cell stack 124 through electric wires which are disposed such that end portions of the electric wires which are on the side of the stack 124 extend along the end faces of the end plate 130 which are opposed to each other in the longitudinal direction of the vehicle. Where the electric wires connecting the relay 140, etc. and the stack 124 are disposed as described above, the electric wires may be squeezed between the end faces of the end plate 130 and devices or components which are located adjacent and opposite to the end faces, in the event of crashing of the vehicle. Therefore, this arrangement of the electric wires may cause breakage or disconnection of the electric wires. In the fuel cell module 120 according to the present embodiment, however, the terminals 138 of the terminal electrodes 134, 136 electrically connected to the fuel-cell stack 124 extend through the respective elongate openings 139 formed through the end plate 130, so that the terminals 138 are located on the outer side of the end plate 130 which extends in the longitudinal direction of the vehicle. In the present arrangement, the terminals 138 are located at the central portion of the end plate 130, namely, spaced apart from the end faces of the end plate 130 and the adjacent devices or components, so that the terminals 138 are prevented from being directly influenced by an impact force generated upon crashing of the vehicle.

Even when the relay 140 is placed in its OFF state, a high voltage is present between the terminal electrodes 134, 136 of the fuel-cell stack 124 and the relay 140. In the present fuel cell module 120, however, the length of the flexible bus bar 142 connecting the terminals 138 and the relay 140 can be made relatively small since the openings 139 through which the terminals 138 extend are located at the central portion of the end plate 130. Namely, the length of the electric wires to which the high voltage is applied while the relay 140 is in the OFF state is minimized to improve the safety of the fuel cell module 120.

As shown in FIG. 1, the side wall of the casing 122 on the side of the end plate 130 is provided with a service plug 150. This service plug 150, which is attached to a rear portion of the above-indicated side wall, consists of a fixing portion 152 fixed to the casing 122, and a plug portion 154 which is removably attached to the fixing portion 152 and which is located outside the casing 122. A terminal block 160 is attached to the outer surface of an rear end portion of the end plate 130 which is located adjacent to the service plug 150. The fixing portion 152 of the service plug 150 is electrically connected to the relay 140 through the terminal block 160. Described more specifically, a harness 162 connected to the fixing portion 152 and a bus bar 164 connected to the relay 140 are electrically connected to each other by the terminal block 160. Thus, the relay 140 and the fixing portion 152 of the service plug 150 are electrically connected to each other, for each of the positive and negative terminal electrodes 134, 136.

A power supply cable 166 extends from the fixing portion 152 of the service plug 150, through the casing 122 and outwardly of the casing 122. When the plug portion 154 is attached to the fixing portion 152, the harness 162 connected to the fixing portion 152 is electrically connected to the power supply cable 166. When the plug portion 154 is removed from the fixing portion 152, the harness 162 and the power supply cable 166 are disconnected from each other. For instance, the plug portion 154 is removed from the fixing portion 152 by a person who wants to perform a maintenance operation on the vehicle. The removal of the plug portion 154 assures safety against electrical leakage or short-circuiting.

The fuel cell module 120 is supplied with a cooling water circulated through a radiator (not shown). To this end, the end plate 132 has an inlet 170 and an outlet 174 for the cooling water.

Then, the flexible bar 142 will be explained. As described above, the dimension of the fuel-cell stack 124 in the direction of lamination varies due to expansion and contraction thereof with a variation of the temperature caused by heat generated by the stack 124. The dimension also have a variation due to manufacturing errors of the stack 124. On the other hand, the end plates 130, 132 are fixed to the vehicle body 100. Accordingly, the terminals 138 may be moved relative to the end plate 130, and a distance of projection of the terminals 138 from the end plate 130 may vary. The flexible bus bar 142 is flexible and is able to absorb or accommodate a variation of the distance of projection of the terminals 138 due to their movement and/or the manufacturing errors of the stack 124. Accordingly, the flexible bus bar 142 connecting the terminals 138 and the relay 140 is protected against breakage or disconnection.

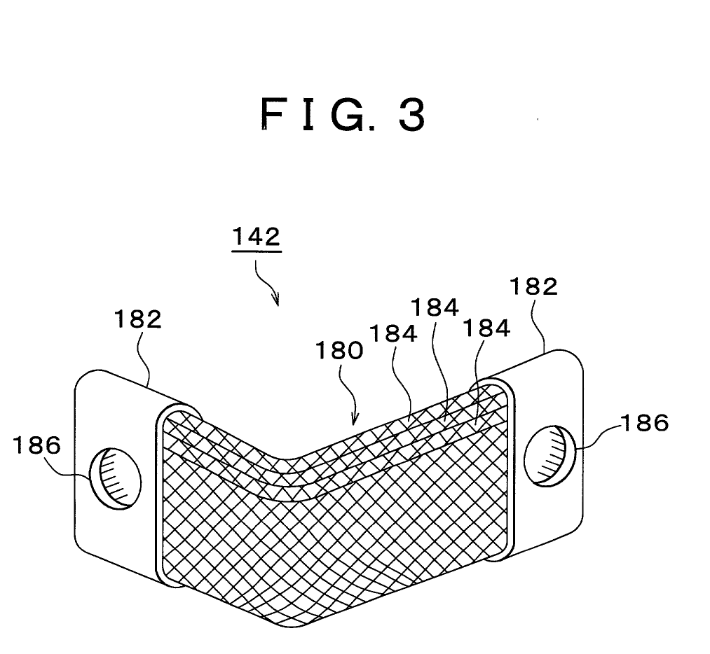

Referring next to the perspective view of FIG. 3, there is schematically shown an arrangement of the flexible bus bar 142. The flexible bus bar 142 consists of a bus-bar portion 180 having a relatively high degree of flexibility, and two terminals 182 located at the opposite ends of the bus-bar portion 180. For example, the bus-bar portion 180 consists of a plurality of planar reticulate or network conductors 184 each formed by braiding or knitting relatively thin copper wires and having a high degree of flexibility. These planar reticulate conductors 184 are superposed on each other in a direction of application of a bending force thereto, so that the bus-bar portion 180 is given a relatively large area in transverse cross section, without deterioration of the flexibility of the flexible bus bar 142, enabling the fuel cell stack 124 to supply a large amount of electric current with a reduced power loss. The bus-bar portion 180 is bent into an L-shaped structure, to facilitate the electrical connection between the terminals 138 projecting at right angles from the end plate 130 and the relay 140 disposed in a juxtaposed relationship with the terminals 138. The terminals 182 are press-fitted on the respective end portions of the bus-bar portion 180, and have respective screw holes 186. The flexible bus bar 142 is fixed to the terminals 138 and relay 140 by inserting screws through the screw holes 186 formed through the terminals 182.

The combination of the vehicle body 100 and the fuel cell module 120 installed on the vehicle body 100, which is arranged according to the present embodiment of this invention is effective to reduce a possibility of damaging or destruction of the power output portion of the fuel cell module 120 upon crashing of the vehicle, since the power output portion of the fuel cell module 120 which includes the terminals 138, relay 140, service plug 150 and terminal block 160 is disposed or oriented so as to face generally in the lateral direction of the vehicle. In particular, the damaging or destruction of the power output portion of the fuel cell module 120 is effectively prevented by the arrangement wherein the terminals 138 constituting a part of the power output portion extend through the openings 139 formed through the end plate 130 extending in the longitudinal direction of the vehicle. Further, the relay 140 provided to prevent electrical leakage or short-circuiting is attached to the end plate 130 such that the relay 140 is disposed relatively near the terminals 138, so that the length of the flexible bus bar 142 which connects the terminals 138 and the relay 140 and is at a high voltage when the relay 140 is in the OFF state, can be shortened, resulting in an improved degree of safety in connection with the electrical leakage. Further, the use of the flexible bus bar 142 having a high degree of flexibility as electric wires for connecting the terminals 138 and the relay 140 makes it possible to absorb movements of the terminals 138 which may take place due to thermal expansion and contraction of the stacks 126, 128 of the cells 125, thereby reducing a possibility of breakage or disconnection of the electric wires connecting the terminals 138 and the relay 140.

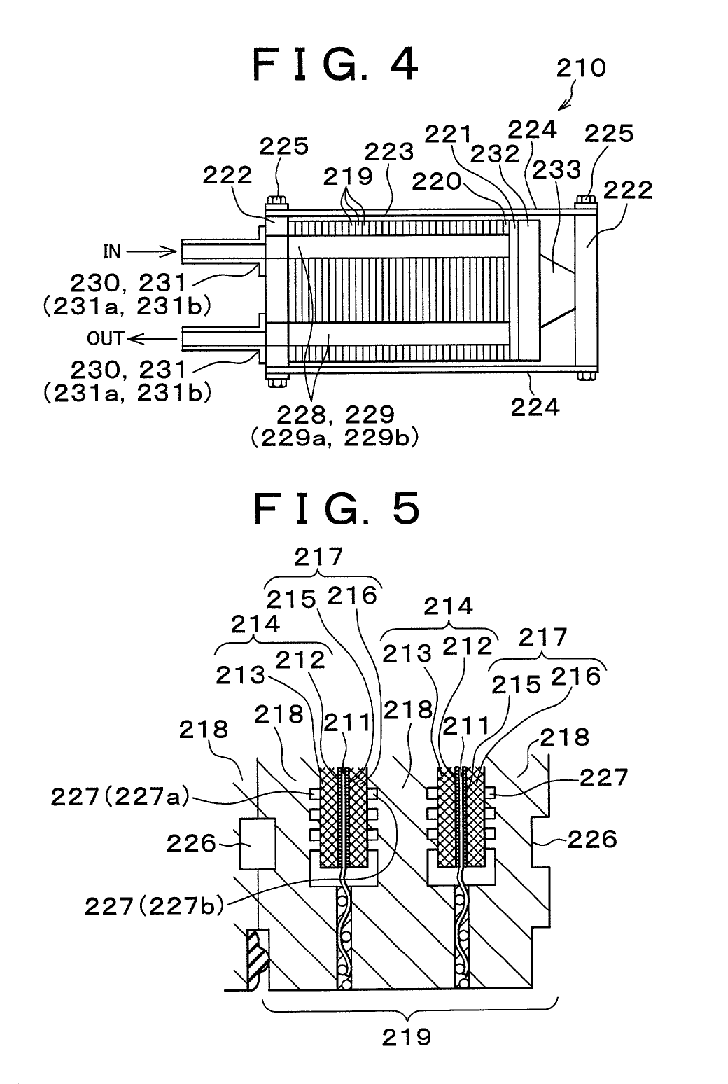

Referring next to FIGS. 4-10, there will be described a fuel cell which is constructed so as to protect various pipes, according to a second embodiment of this invention.

The fuel cell of the second embodiment, which is provided with a cell monitor to monitor a cell voltage, is a solid polyelectrolyte type fuel cell 210. For example, this type of fuel cell 210 is installed on a fuel-cell powered automotive vehicle. However, the fuel cell 210 may have other applications.

As shown in FIGS. 4 and 5, the solid polyelectrolyte type fuel cell 210 has a stack 223 which is fixed by tightening members or tension plates 224 and bolts 225.

The stack 223 consists of a multiplicity of modules 219 laminated on each other, and two sets of a terminal 220, an insulator 221 and an end plate 222, which two sets are disposed at the respective opposite ends of a laminated structure of the modules 219 as seen in the direction of lamination of the modules 219.

Each of the modules 219 consists of a plurality of cells.

Each cell consists of a separator 218 and a membrane-electrode assembly (MEA) which are superposed on each other.

The separator 218 has a fluid passage 227 (fuel-gas passage 227a and oxidizing-gas or air passage 227b ) for supplying electrodes 214 and 217 with a fuel gas (hydrogen) and an oxidizing gas (oxygen, usually, air), and a refrigerant passage (cooling water passage) 226 through which a refrigerant (cooling water) for cooling the fuel cell 210 flows.

The membrane-electrode assembly consists of an electrolyte membrane 211, the electrode 214 (anode, i.e., fuel electrode or negative electrode) and the electrode 217 (cathode, i.e., air electrode or positive electrode). The electrolyte 211 consists of an ion-exchange membrane, and the electrode 214 (anode, i.e., fuel electrode or negative electrode) consists of a catalyst layer 212 and a diffusion layer 213, while the electrode 217 (cathode, i.e., air electrode or positive electrode) consists of a catalyst layer 215 and a diffusion layer 216.

At one of the opposite ends of the stack 223, there is interposed a pressure plate 232 between the end plate 222 and the insulator 221. Further, a spring mechanism 233 is interposed between the pressure plate 232 and the end plate 222, so that the modules 219 are evenly forced against each other.

The cooling-water passage 226 is provided for each of the modules 219, or for the two or more modules 219.

Each separator 218 may be a carbon plate or a resin plate through which the cooling-water passage 226 and the fluid or gas passage 227 (fuel-gas passage 227a and oxidizing-gas passage 227b) are formed. The resin plate contains electrically conductive particles mixed with a resin material, to exhibit a high degree of electrical conductivity. Alternatively, the separator 218 may consist of a plurality of corrugated metal sheets which are superposed on each other so as to define the passages 226, 227. In the present embodiment shown in FIG. 4, the separator 218 consists of a carbon plate.

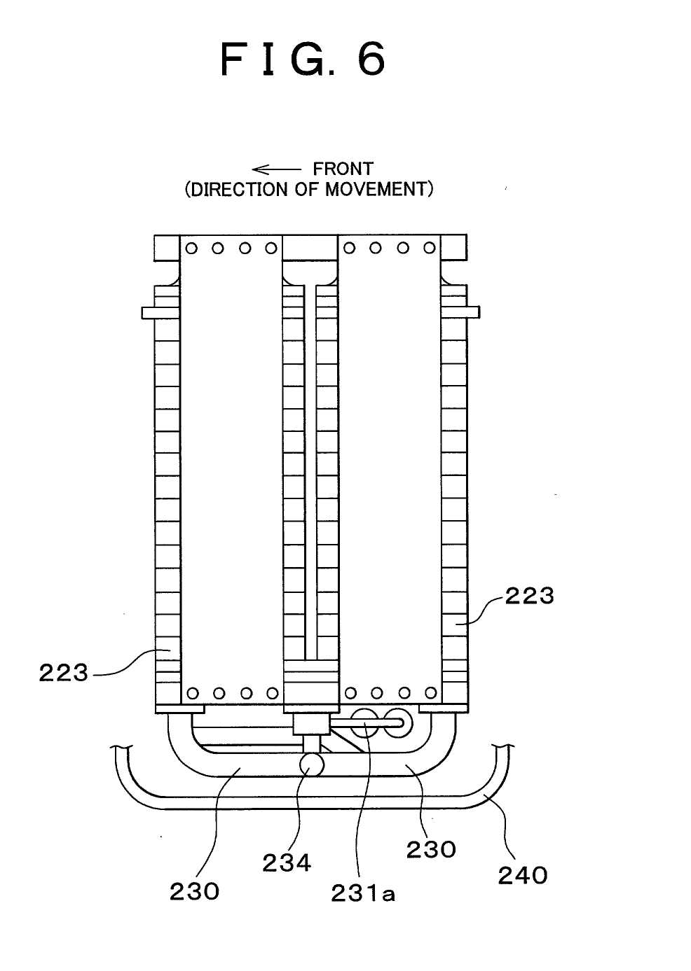

The separators 218 isolate the fuel gas and the oxidizing gas from each other, the fuel gas and the cooling water from each other, or the oxidizing gas and the cooling water from each other. The separators 218 are electrically conductive members, which define electron paths through which the electrons flow between the anode and cathode of the adjacent modules 219.

Where the fuel cell 210 consists of two stacks 223, as shown in FIG. 6, these two stacks 223 are disposed in a juxtaposed relationship with each other such that the modules 219 are superposed or laminated on each other in the horizontal direction. In this case, the two end plates 222 at the ends of each stack 223 are used commonly for the two stacks 223.

The two parallel stacks 223 are installed on the vehicle body 100 such that the direction of lamination of the modules 219 is perpendicular to the longitudinal direction of the vehicle, that is, is parallel to the lateral direction of the vehicle, while the tension plates 224 are spaced apart from each other in the vertical direction and are held parallel to the horizontal plane.

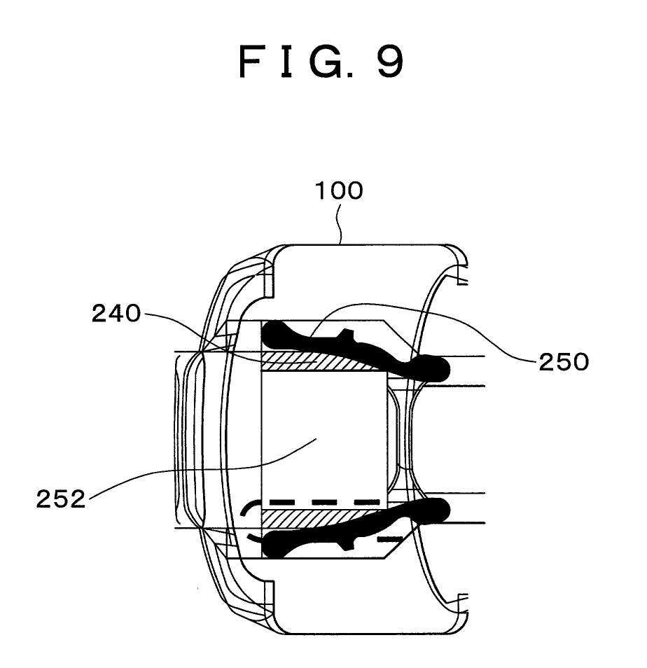

The two stacks 223 are accommodated in a single common casing 240 fixed to the vehicle body 100 as shown in FIGS. 9, such that the two stacks 223 are arranged in the longitudinal direction of the vehicle body 100, as shown in FIG. 6.

The casing 240 accommodating the fuel cell 210 may be disposed in an engine compartment of the vehicle body 100 such that the casing 240 is located between both ends of a sub-frame 250 of the vehicle body 100 as shown in FIGS. 9.

As shown in FIGS. 4, 7 and 10, the fuel-cell stacks 223 have refrigerant manifolds 228 formed therethrough. These refrigerant manifolds 228 are held in communication with the refrigerant passages 226 of the modules 219. A refrigerant flows from the inlet-side refrigerant manifolds 228 into the refrigerant passages 226, and is discharged from the refrigerant passages 226 into the outlet-side refrigerant manifolds 228.

Similarly, the fuel-cell stacks 223 have gas manifolds 229 formed therethrough. The gas manifolds 229 consist of fuel-gas manifolds 229a and oxidizing-gas manifolds 229b, which are held in communication with the fuel-gas passages 227a and the oxidizing-gas passages 227b of the modules 219, respectively. The fuel gas flows from the inlet-side fuel-gas manifolds 229a into the fuel-gas passages 227a, and is discharged from the fuel-gas passages 227a into the outlet-side fuel-gas manifolds 229a. The oxidizing gas flows from the inlet-side oxidizing-gas manifolds 229b into the oxidizing-gas passages 227b, and is discharged from the oxidizing-gas passages 227b into the outlet-side oxidizing-gas manifolds 229b.

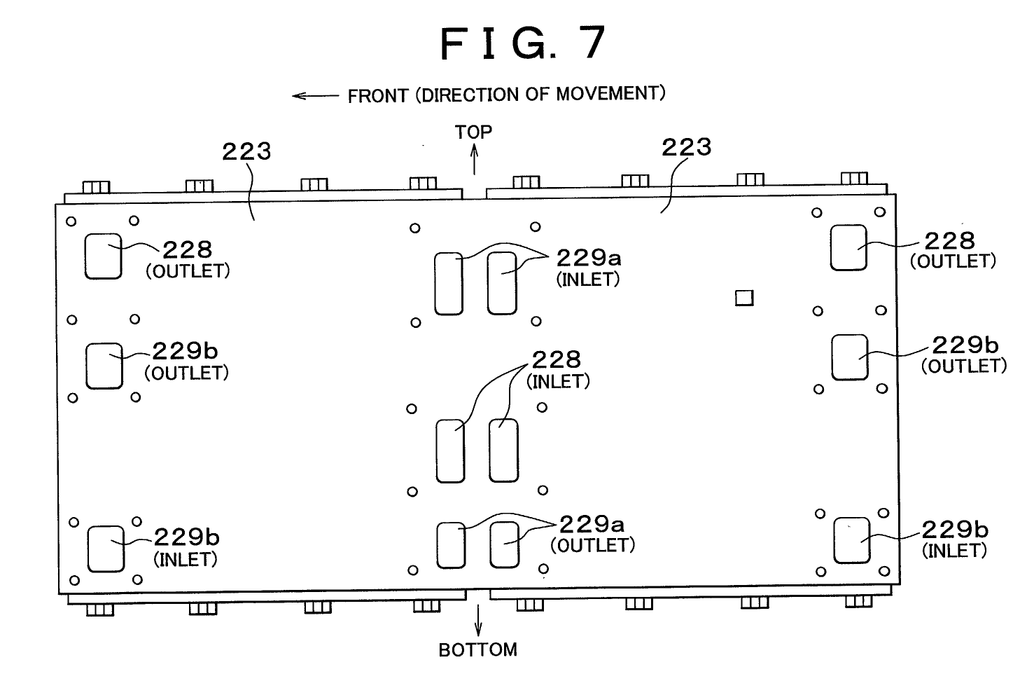

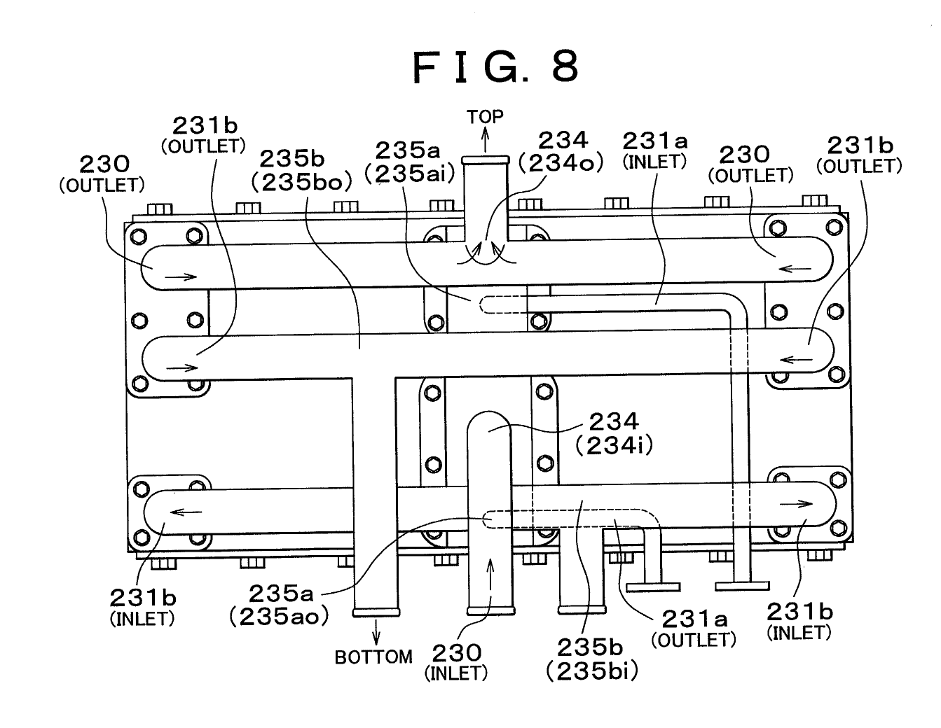

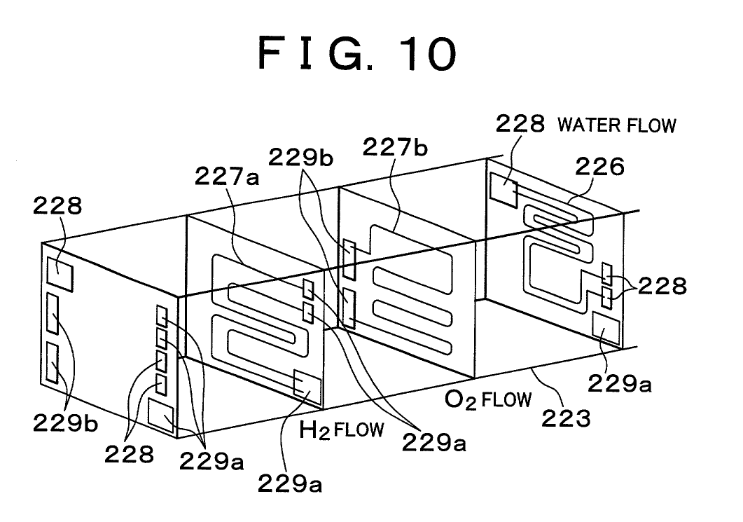

As shown in FIGS. 4, 6 and 8, coolant pipes 230 for supplying and discharging the refrigerant (cooling water) into and from the refrigerant manifolds 228 of the fuel-cell stacks 223 are connected to one end of the stacks 223 which is remote from the pressure plate 232 and spring mechanism 233. To the coolant pipes 230, there are connected gas pipes 231 as shown in FIG. 8. The gas pipes 231 are provided to supply and discharge the reaction gases into and from the gas manifolds 229 (FIGS. 7 and 10) within the fuel-cell stacks 223. The gas pipes 231 consist of fuel-gas pipes 231a for supplying and discharging the fuel gas into and from the fuel-gas manifolds 229a within the stacks 223, and oxidizing-gas pipes 231b for supplying and discharging the oxidizing gas into and from the oxidizing-gas manifolds 229b within the stacks 223. The refrigerant, fuel-gas and oxidizing gas admitted into the fuel-cell stacks 223 through the end plate 222 remote from the spring mechanism 233, and are discharged or exhausted from the stacks 223 through the same end plate 222, after flowing through the stacks 223 along U-shaped paths.

In the example of FIG. 8, the refrigerant (cooling water) flowing through the inlet-side coolant pipe 230 is distributed by a distributing part 234_{I} of a refrigerant distributing-merging portion 234, to flow into the front and rear stacks 223 through a relatively lower part of a central portion of the above-indicated end plate 222, which central portion is central as seen in the longitudinal direction of the vehicle. Two streams of the refrigerant which have flowed through the front and rear stacks 223 are discharged through relatively upper parts of the respective opposite end portions of the same end plate 222, to flow into the front and rear outlet-side coolant pipes 230, so that the two streams of the refrigerant merge together at a merging part 234_{O} of the refrigerant distributing-merging portion 234, which is located at a relatively upper central portion of the end plate 222. The refrigerant then flows upwards from the merging part 234_{O}.

The fuel gas flowing through the inlet-side fuel-gas pipe 231a is distributed by a distributing part 235a_{I}, of a fuel-gas distributing-merging portion 235a, to flow into the front and rear stacks 223 through a relatively upper central portion of the above-indicated end plate 222. Two streams of the fuel gas which have flowed through the front and rear stacks 223 are discharged through a relatively lower central portion of the same end plate 222, to flow into the front and rear outlet-side fuel-gas pipes 231a, so that the two streams of the fuel gas merge together at a merging part 235a_{O} of the fuel-gas distributing-merging portion 235a, which is located at a relatively lower central portion of the end plate 222. The fuel gas flows sideways from the merging part 235a_{O} and then downwards.

The oxidizing gas flowing through the inlet-side oxidizing-gas pipes 231b is distributed by a distributing part 235b_{I} of an oxidizing-gas distributing-merging portion 235b, to flow into the front and rear stacks 223 through a relatively lower central portion of the end plate 222. Two streams of the oxidizing gas which have flowed through the front and rear stacks 223 are discharged through relatively upper end portions of the end plate 222, to flow into the front and rear outlet-side oxidizing-gas pipes 231b, so that the two streams of the oxidizing gas merge together at a merging part 235b_{O} of the oxidizing-gas distributing-merging portion 235b, which is located at a relatively upper central portion of the end plate 222. The fuel gas then flows downwards from the merging part 235b_{O}.

The distributing-merging portions 234, 235a and 235b for connecting the coolant pipes 230, fuel-gas pipes 231ak and oxidizing-gas pipes 231b to the stacks 223 are also accommodated in the casing 240 in which the stacks 223 are accommodated. The refrigerant distributing-merging portion 234 is provided for connecting the inlet-side coolant pipe 230 to the front and rear stacks 223 and for merging the two outlet-side coolant pipes 230 together. The fuel-gas distributing-merging portion 235a is provided for connecting the fuel-gas pipe 231a to the front and rear stacks 223 and for merging the two outlet-side fuel-gas pipes 231a together. The oxidizing-gas distributing-merging portion 235b is provided for connecting the inlet-side oxidizing-gas pipes 23b to the front and rear stacks 223 and for merging the two oxidizing-gas pipes 231b together. The refrigerant distributing-merging portion 234 includes the distributing part 234_{I} and the merging part 234_{O}, and the fuel-gas distributing-merging portion 235a includes the distributing part 235a_{I} and the merging part 235a_{O}, while the oxidizing-gas distributing-merging portion 235b includes the distributing part 235b_{I} and the merging part 235b_{O}.

Various fluid pipes for connection between the stacks 223 and the distributing-merging portions 234, 235a, 235b of the fluid pipes 230, 231a, 231b are also accommodated in the casing 240 in which the stack 223 are accommodated.

As shown in FIGS. 6 and 8, the casing 240 is disposed within an engine compartment 253. The fuel-gas pipes 231a, oxidizing-gas pipes 231b and coolant pipes 234 are connected to one of the longitudinal opposite ends of the stacks 223 of the fuel cell 210 accommodated in the casing 240. Those longitudinal opposite ends of the stacks 223 are opposed to each other in the lateral direction of the vehicle (vertical direction as seen in FIG. 6). Of the pipes 230, 231a, 231b connected to one of the longitudinal opposite ends of the stacks 223, the fuel-gas pipes 231a are located most inwardly in the lateral direction of the vehicle, such that the fuel-gas pipes 231a disposed within the casing 240 are located between and protected by the stacks 223 and the other pipes 231b and 230 which are located relatively outwardly in the lateral direction of the vehicle.

Described more specifically, the inlet-side fuel-gas pipe 231a disposed within the casing 240 is located between the end portions of the outlet-side coolant pipes 230 as seen in the longitudinal direction of the vehicle, while the outlet-side fuel-gas pipe 231a is between the end portions of the inlet-side oxidizing-gas pipes 231b as seen in the longitudinal direction of the vehicle. Further, the inlet-side fuel-gas pipe 231a is located more inwardly in the lateral direction of the vehicle than the outlet-side coolant pipes 230, that is, between the stacks 223 and the pipes 230, while the outlet-side fuel-gas pipe 231a is located more inwardly in the lateral direction of the vehicle than the inlet-side oxidizing-gas pipes 231b, that is, between the stacks 223 and the pipes 231b.

There will be described advantages of the combination of the vehicle body and the fuel cell 210 installed thereon according to the second embodiment of this invention.

In the second embodiment, not only the stack 223 or stacks 223 but also the fluid pipes 230, 231a, 231b connected to the stacks 223 are accommodated in the casing 240. Of the fuel-gas pipes 231a, oxidizing-gas pipes 231b and coolant pipes 230, the fuel-gas pipes 231a are located most inwardly in the lateral direction of the vehicle, namely, located most nearest to the stack or stacks 223 in the lateral direction of the vehicle. To be more precise, if the stack 223 is single, the fuel-gas pipes 231a are located next to the stack 223 in lateral direction with respect to the vehicle. If the stacks 223 are plural, the fuel-gas pipes 231a are disposed on the portion being close to an adjacent stacks 223 in longitudinal direction with respect to the vehicle as shown in FIG. 8. This location of the fuel-gas pipes 231a is effective to protect the pipes 231 against a fuel gas leakage and consequent problems that may take place upon crashing of the vehicle, thereby improving the safety of the vehicle. Since the fuel-gas pipes 231a are located most nearest to the stack or stacks 223, these pipes 231a are protected upon crashing of the vehicle, so as to minimize possible fuel gas leakage and consequent problems.

Even if any member of the vehicle body comes into abutting contact with the casing 240 upon crashing of the vehicle, deformation of the casing 240 is restricted after the casing 240 is locally brought into contact with the oxidizing-gas pipes 231b and coolant pipes 230, so that the fuel-gas pipes 231a are unlikely to be damaged by deformation of the casing 240, whereby the fuel gas leakage and the consequent problems are prevented or minimized in the event of a crashing of the vehicle.

It is also appreciated that the fluid pipes such as the fuel-gas pipes 231a are attached to one of the longitudinal opposite ends of the stack or stacks 223 which are opposed to each other in the lateral direction of the vehicle. Namely, none of the fluid pipes are attached to the front side of the stack or stacks 223. Although any members of the vehicle and the casing 240 may be deformed in the event of a front crashing of the vehicle, the amount of this deformation is restricted by the stack or stacks 223, so that the fuel-gas pipes 231a are protected from damaging upon crashing of the vehicle.

It is further noted that the casing 240 accommodating the stack or stacks 223 is located between the front and rear ends of the sub-frame 250 in the longitudinal direction of the vehicle and between the right and left ends of the sub-frame 250 in the lateral direction of the vehicle, as shown in FIGS. 9. Accordingly, the casing 240 and the fuel cell 210 and the pipes 230, 231a, 231b accommodated within the casing 240 are effectively protected by the surrounding members, the sub-frame 250 and the inverter 252.

In addition, the fluid pipes 230, 231a,231b are attached to one of the two end plates 222 of the stack or stacks 223 which is remote from the spring mechanism 233, as shown in FIG. 6, so that the pipes can be connected to the manifolds extending through the laminar structure of the modules 219, making it possible to facilitate the connection between the manifolds and the pipes.

If the fluid pipes 230, 231a, 231b were attached to the end plate 222 on the side of the spring mechanism 233, the manifolds might be comparatively easily broken due to a gap or spacing between the end plate 222 and the pressure plate 232. Accordingly, the arrangement required to connect the manifolds and the fluid pipes is complicated, and the positioning of the fluid pipes relative the stack or stacks 223 and within the casing 240 tends to be difficult, so that the fluid pipes are comparatively likely to be subject to an impact force in the event of a crashing of the vehicle, and less likely to be suitably protected from damage.

What is claimed is:

1. A mounting structure of a fuel cell assembly on a vehicle body comprising:
a vehicle body and;
a fuel cell assembly including a power output portion which is provided at side portion of the fuel cell assembly, and which is installed in a front portion of the vehicle body such that the power output portion faces to a lateral direction with respect to the vehicle.

2. The mounting structure according to claim 1, wherein
the fuel cell assembly includes a stack of cells laminated on each other in the lateral direction with respect to the vehicle, and rigid end plates disposed at respective opposite ends of the stack of cells such that the cells are forced against each other by the rigid end plates, and
the power output portion includes terminal electrodes which are connected to the stack of cells, and which include terminals extending through openings formed through rigid end plates outwardly of the stack in the lateral direction.

3. The mounting structure according to claim 2, further comprising
a relay which is attached to an outer surface of the rigid end plates, and is operable to cut off an electric current from the fuel cell assembly by an external control signal.

4. The mounting structure according to claim 3, further comprising
a flexible wiring member connecting the relay and the terminal electrodes.

5. The mounting structure according to claim 1, wherein
the fuel cell assembly is disposed in an engine compartment of the vehicle, and is provided with a fuel-gas pipe connected to the fuel cell assembly, and
at least one component is located between the fuel-gas pipe and inside wall of the vehicle body.

6. The mounting structure according to claim 5, wherein
the at least one component includes at least one of oxidizing-gas pipe and coolant pipe connected to the fuel cell assembly.

7. The mounting structure according to claim 5, wherein
the fuel cell assembly includes a stack of cells, and is disposed in the vehicle body such that a direction of lamination of the cells is parallel to the lateral direction with respect to the vehicle.

8. The mounting structure according to claim 1, wherein
the fuel cell assembly including a stack of cells, is disposed under an openable body panel of the vehicle, and is provided with a fuel-gas pipe connected to the fuel cell assembly and
at least one component is located between the fuel-gas pipe and inside wall of the vehicle body.

9. The mounting structure according to claim 8, wherein
the at least one component includes at least one of an oxidizing-gas pipe and a coolant pipe connected to the fuel cell assembly.

10. The mounting structure according to claim 8, wherein
the fuel cell assembly includes a stack of cells, and is disposed in the vehicle body such that a direction of lamination of the cells is parallel to the lateral direction with respect to the vehicle.

11. The mounting structure according to claim 1, wherein
the fuel cell assembly is disposed under an openable body panel of the vehicle, includes a plurality of stacks of cells such that a direction of lamination of the cells is parallel to the lateral direction with respect to the vehicle, and is provided with a fuel-gas pipe connected to the fuel cell assembly, and
wherein the fuel-gas pipe is disposed on a portion of an end of the stacks, the portion being closer than the center of the end to an adjacent stack.

12. The mounting structure according to claim 11, wherein
the fuel cell assembly includes a stack of cells, and is disposed in the vehicle body such that a direction of lamination of the cells is parallel to the lateral direction with respect to the vehicle.

13. The mounting structure according to claim 1, wherein
the fuel cell assembly is disposed outside a passenger compartment of the vehicle and within the front portion of the vehicle body, and includes a stack of cells, and
the fuel cell assembly is disposed in the vehicle body such that a direction of lamination of the cells is parallel to the lateral direction with respect to the vehicle.
